(19) United States
(12) Patent Application Publication
(10) Pub. No.: US 2011/0285062 A1
(43) Pub. Date: Nov. 24, 2011

(54) METHOD FOR REGULATING THE TEMPERATURE OF A HOT ISOSTATIC PRESS, AND HOT ISOSTATIC PRESS

(75) Inventor: Matthias Graf, Bretten (DE)

(73) Assignee: Dieffenbacher GmbH +CO. KG

(21) Appl. No.: 13/130,557

(22) PCT Filed: Nov. 23, 2009
(86) PCT No.: PCT/EP2009/008329

§ 371 Date: Aug. 8, 2011

(30) Foreign Application Priority Data
Nov. 23, 2008 (DE) 10 2008 058 330.8

(51) Int. Cl. B29C 43/12

(52) U.S. Cl. 264/517; 425/405.2

(57) ABSTRACT

The invention relates to a method for regulating the temperature of a hot isostatic press and to a hot isostatic press, consisting of a pressure vessel (1) having an interior loading space (19) and insulation (8) arranged in between, wherein heating elements (4) and a loading space (19) having a load (18) are arranged inside the insulation (8), wherein at least the loading space (19) is surrounded by a convection sleeve (27) to form a convection gap (28). Fluid is sprayed through at least one nozzle (13) in the interior of the pressure vessel (1) and/or the loading space (19) to generate a rotational flow (23) so that said fluid mixes with the fluid held therein, and said fluid simultaneously forms a circulation (29) around the convection sleeve (27) and enters the loading space (19) via the convection gap (28). The invention also relates to a hot isostatic press in which at least one conduit (12) that is connected to at least one nozzle (13) within the pressure vessel (1) is arranged inside the pressure vessel (1), wherein the discharge angle of the nozzle (13) is suited to form a rotational flow (23) within the loading space (19), and wherein the conduit (12) is connected to an area of the pressure vessel (1) having a different temperature.

The invention relates to a method for tempering a hot isostatic press according to the preamble of claim 1 and a hot isostatic press according to the preamble of claim 12.

Hot isostatic presses (HIP) or autoclave-kilns are used for various applications today. Here, solid work pieces or molding material comprising powder are compressed in a matrix under high pressure and high temperature. Here, similar as well as different materials can be connected with each other. Generally, the work pieces are inserted into a kiln with a heater, which in turn is encompassed by a high pressurized vessel. During or after heating, caused by the pressure of a fluid and/or inert gas, usually argon from all sides, a complete isostatic compression is performed until the work pieces are optimally compressed. This method is also used to post-compress components, for example comprising ceramic materials, e.g., for hip replacements, for cast aluminum parts in the automotive or engine construction, as cylinder heads for vehicle engines, or precision molded parts comprising titanium alloys, e.g., turbine buckets. In a post-compression under high pressure and high temperature the pores are closed that developed in the previous production process, existing gaps connected, and the composite features improved. Another field of application is the production of parts close to their final shape made from powder materials, which are compressed in the process and sintered.

In general, HIP-cycles last very long, from a few hours to several days. A considerable portion of the cycle costs is here caused by the rate of machine hours due to the capital lockup. Particularly the relatively long cooling periods from the operating temperature to a temperature permitting to open the press arrangement without risk usually amount to more than one third of the cycle period and are not beneficial for the technical process. It is known that the cooling process is also of an essential role for the material features of the parts to be produced. Many materials require the compliance with a certain maximum cooling speed for reasons of material quality. Here, it must be observed during the cooling process that a work piece itself with its volume is evenly cooled and not unevenly with different temperature zones. In the production of large parts, intrinsic stress may lead to distortions, fractures with the corresponding notching effect, or even a complete destruction. But even in small parts, which usually are deposited in a rack or shelf in the kiln, such problems may arise.

Convection autoclaves with or without any mechanical means, such as blowers, are sufficiently known in prior art. In the application without any mechanical means the natural convection and the redistribution of the pressure means in the autoclaves are established by existing or supported temperature differences (heating or cooling at the exterior walls). Here, colder fluid falls downward and hotter fluid rises. By the use of guiding organs such fluid flows can be used in a controlled fashion in order to create an even heating or cooling exchange in the autoclave. In prior art, here preferably so-called guiding or convection sheaths are used, comprising a tube open at the top and the bottom. During the heating process, heat sources in the kiln ensure for the drive and the flow develops depending on the arrangement of the heat source. For example, heating occurs in the charge space (underneath the load) and an upward flow develops in the center of the charge space and a downward flow towards the outside along the walls (cooler temperature). In order to avoid problems with uncalculated, mixed flows the above-mentioned convection sheath offers the advantage that in the convection gap (between the convection sheath and the insulation towards the outside) a controlled down flow is generated, thus ensuring that the fluids cooled again first enter the heating area and are reheated before they reenter the charge space. In the cooling process the cooled fluid also falls downward between the convection sheath and the cooling exterior wall/insulation, where it enters the charge space as the colder fluid and thus pushes the warmer fluid inside the convection sheath upwards, passing the charge. At the lid of the HIP-arrangement the flow coming from below pushes the fluid in the direction of the exterior areas and thus the fluid falls back down between the exterior wall and the convection sheath. Here, a respective cooling effect develops once more, maintaining the continuous cooling process. An at least similar process has become known in WO 2003/070 402 A1 and a method presented here for the cooling of a hot isostatic press. In the method described here the hot fluid is released from the charge space, mixed with a cool falling fluid outside the charge space, and the mixed fluid is returned to the charge space. The method itself is complex in its targeted conditions and additionally requires an even more complex design of a corresponding hot isostatic press with many guiding sections arranged, here. It is also disadvantageous that the reinserted mixed fluid flows back into the charge space in an uncontrolled fashion and may here perhaps lead to different cooling speeds when undercuts of the charge or support structures of said charge prevent any orderly flow through the charge space. Additionally, the gas cooled to the mixing temperature is fed to the charge space from below, which mandatorily leads to a temperature difference between the bottom end and the top end of the charge space and thus prevents any even cooling speed from being realized.

An embodiment for a rapid cooling of a HIP-arrangement is known for example from DE 38 33 337 A1. In this solution to be used for rapid cooling a gaseous circulation is created between the heat chamber inside the insulating cap and the cooling chamber outside the insulating cap by opening the circulation via valves in the floor area. In the upper lid of the insulating cap permanently open bore holes are provided, via which the hot fluid can exit. This embodiment is disadvantageous in that very cold fluid flows back into the heat chamber from the bottom and directly contacts the charge of the kiln and/or the work pieces. The heated space is therefore filled with cold gas from the bottom towards the top. This is disadvantageous in that on the one hand a rapid cooling can develop with imprecisely controlled parameters and that no even cooling speed is achieved over the entire charge space. Particularly in large parts here, due to the uneven cooling process, the above-described problems can occur, such as distortions, fractures, or destruction. Summarizing, it is known to one trained in the art that in the technologically important temperature maintenance phase the charge in the charge space is held at a very narrow tolerance range of ±5° C., for example. In this phase the known pressurized vessel systems tend to separate hot and cold gas in the charge space. By targeted countermeasures using the active heating elements it is attempted to compensate this effect. However, the heating elements in the pressurized vessel systems act at the jacket surfaces of the charge space and thus cannot completely prevent any separation in the interior of the charge space. In an embodiment according to WO 2003/070 402 A1 an active convection flow through the charge space is used in a targeted fashion, with however in the maintenance phases for example between the heating phase and the cooling phase or gradual changes of the temperature the convection flow almost stops and thus the desired effect cannot be achieved any more due to the reduction of the required heating power occurring here. In other pressurized vessel systems with convection blowers the flow is aligned purely vertically through the charge space. Here, depending on the design and/or geometry of the load and/or loading frames used an uneven flow can develop in the pressurized vessel when zones with different flow resistances develop. Due to the fact that a fluid flow adjusts to the path of least resistance, zones with less flow resistance are better and faster flown through and accordingly tempered more rapidly. Accordingly, areas with no or little flow are adjusted less rapidly to the new temperature conditions and an uneven temperature distribution develops in the pressurized vessel and/or the charge space.

The objective of the present invention comprises to provide a method for an even tempering of a hot isostatic press and to create a hot isostatic press, which is not only suited to perform the method but can be operated independently with the advantages of an even tempering.

The focus is of course the even cooling of the charge space and/or the charge, with a colder fluid quickly being mixed with the hot fluid in the pressurized vessel and/or preferably in the charge space of the hot isostatic press and simultaneously a sufficiently fast and primarily secure exchange of the fluid is achieved in the entire pressurized vessel, particularly in the charge space, in order to achieve an even cooling of the entire charge. The method may also be used advantageously in the heating and maintenance phase of the hot isostatic process in order to achieve the best-possible temperature homogeneity in the charge space.

The objective of the method is attained according to claim 1 such that inside the pressurized vessel and/or the charge space fluid is injected via at least one nozzle for the formation of a rotational flow and here mixes with the fluid present and that simultaneously the fluid forms a circulation around the convection sheath, entering the charge space from the convection gap, that in the upper area of the pressurized vessel inside the charge space fluid is injected via at least one jet for the formation of a rotational flow, with the fluid during the motion of the rotational flow falls downward in the proximity of the insulation passing the charge and mixes with the fluid at the proximity of the charge and with the injected fluid showing a lower temperature than the fluid in the charge space and/or the charge.

The objective is attained for a hot isostatic press, which is also suitable for performing the method, comprising that within the pressurized vessel at least one line connected to at least one nozzle is arranged inside the pressurized vessel, with the exiting angle of the nozzle being suitable to form a rotational flow inside the charge space and with the line being connected to an area of the pressurized vessel having a different temperature.

The isostatic press is suitable to perform the method, however it may also be operated independently. A teaching of the invention comprises that in addition to convection by guiding devices, heaters, cooling devices, injection means, or convection blowers a rotational flow shall be formed inside the pressurized vessel in a targeted fashion. In addition to an incited or already existing natural convection flow with a vertical alignment caused by the temperature differences in the pressurized vessel, this flow shall form a rotational flow at an angle in reference thereto, which optimally ensures the mixing of the existing or added fluid, avoids temperature pockets, and can ensure a high heating and/or cooling gradient.

The advantages can most easily be shown using a preferably quickly performed cooling and/or rapid cooling, with the respective advantages, ongoing processing steps, and/or simultaneous physical reactions with an opposite heating and cooling phase to be applied being easily comprehended and executed by one trained in the art.

In an advantageous manner, during the cooling phase the vertical separation of the cold and hot fluid particles is prevented by the rotational flow and simultaneously the energy transportation from the charge for example to the cooled exterior inside the pressurized vessel is implemented. Increased turbulences develop in the charge space by the rotational flow and simultaneously a longer flowing length, thus more time is given for the fluid to accept and/or release the energy to the charge and/or to other tempered surfaces, such as the cooled exterior. Compared to the vertical flow the charge space is flown through more evenly and no and/or considerably less dead pockets form with insufficient gas and temperature exchange. By the injection at high speed, preferably at the upper end of the charge space, but possibly also in the lower area, a cyclone effect develops inside the charge space, i.e. cooler fluid from the nozzle is circulated by the rotation along the insulation and here falls downward by the higher fluid density. In the exterior area of the charge space mixing occurs between the hot fluid at the proximity of the charge and the cyclonically moved cold fluid. Here, the fluid falling downward entrains hot fluid from the interior of the charge space, resulting in a mixed temperature. By the optimal mixing and the protection of the charge from excessively cold fluid ensured by the laws of physics an optimal and even cooling gradient is ensured of the individual parts of the charge. Due to the rotational motion of the fluid and the corresponding turbulent flows inside the charge space it is also ensured that rising and falling fluids cannot lead to any temperature niches in the charge space due to undercuts of the charge or a charge support. Spatial niches with usually stationary fluid are still sufficiently mixed due to the rotational fluid and the turbulences additionally developing here, in order to perfectly compensate temperature differences. This way it is ensured that even work pieces with undercuts or complex geometries can be evenly cooled (heated). Additionally, the cooling gradient is strongly increased because no laminar protective flow can develop around the work piece or cooling and/or heating elements creating temperature differences and the rotational flows ensure sufficiently turbulent flows towards the work pieces or the cooling and/or heating bodies. This way, the thermodynamic transfer to the work piece considerably increases during the cooling or the heating process.

In order to allow using all advantages of the rotational flow in a beneficial manner it may be provided to arrange a convection sheath in the charge space. This is a preferred embodiment of the invention. By the spatial separation of the charge space now the formation of an independent or at least partially rotary flow is possible inside the convection gap. After the exit from the convection gap in the upper or lower area of the charge space of the pressurized vessel the fluid flows back into the inner charge space and is here entrained by the existing rotational flow and mixed.

This way, an optimal mixing of cooled fluid from the lower area of the charge space with the still warm fluid of the upper area of the charge space results in an advantageous manner and the newly inflowing fluid from the bottom of the pressurized vessel during the cooling phase. Again, this application is possible inversely during the heating process.

Therefore it must be assumed that the fluids flowing in the direction of convection still show a rotary impulse in the convection gap unless they are driven by an active means or are guided by passive means (guiding panels). Advantageously the rotational flows in the convection gap also ensure an optimal mixing and adjustment of the temperatures and prevent punctual temperature differences. Simultaneously the heat transfer between the walls is significantly increased by the turbulent flow. Additionally, the length flown over is considerably extended by the rotational flow, which particularly at tempered surfaces (cooled wall of the pressurized vessel) leads to a considerably better heat transfer and thus a more efficient cooling. The same applies equivalently for the heating process and/or maintenance phase, in which the rotational flow more efficiently guides off the heat created by the heat conductors. Depending on the embodiment, in the convection gap guiding panels or similarly operating resistances may be arranged, which promote the rotational speed of the fluid when rising, brake it, or ensure a better turbulent mixing.

In another preferred exemplary embodiment now two circuits can be implemented in such a pressurized vessel, one inside the area of the charge space and one outside in the area of the wall of the pressurized vessel, with the areas may be separated by thick-walled elements or by insulation. Using simple geometric means the conditions of the flowing fluid and/or the circulatory fluid amounts in the circuits can be adjusted in reference to each other, for example by an adjusted embodiment of the transfer openings or by control means, such as valves. These openings may also be manually adjusted in their size with each new charge.

Summarizing, an optimal and even temperature change develops inside the charge space and temperature differences are avoided. Simultaneously, by adjusting the fluid amount to be exchanged from the exterior to the interior circuit the speed of the cooling process can be controlled from very rapidly to very slowly and can easily be adjusted to the respective application.

Using the features according to the invention it is now possible, at the onset of temperature changes as well as during the maintenance phase, but preferably during rapid cooling, to achieve a homogenous temperature distribution over the entire charge space and/or depending on the design in the entire pressurized vessel. This particularly applies to work pieces with undercuts or for work pieces, which must be placed into particular frames or fasteners. This way it is possible to create a hot isostatic press with very precise process control and very low temperature tolerances in the charge space, which meet the requirements set to HIPs of modern high-performance components. Due to the additionally distanced insulation inside the pressurized vessel two convection circuits with perhaps two corresponding rotational circuits can be implemented. The rotational flow passing the exterior sections of the pressurized vessel ensures an improved temperature acceptance from the walls of the pressurized vessel towards the inside and by the targeted, controlled exchange between the exterior convection circuit and the interior convection circuit the possibility is given to easily control the temperature difference in its intensity.

Other advantageous measures and embodiments of the objective of the invention are discernible from the sub-claims and the following description with the drawing.

It shows:

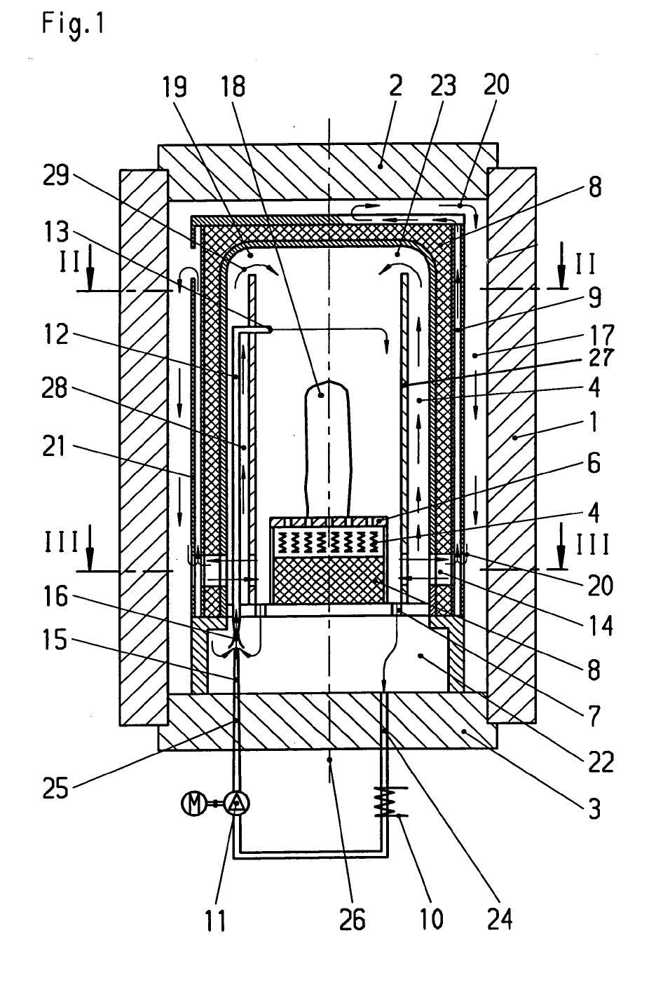

FIG. 1 in a schematic illustration a vertical cross-section through the central axis of a pressurized vessel with an external fluid cooling,

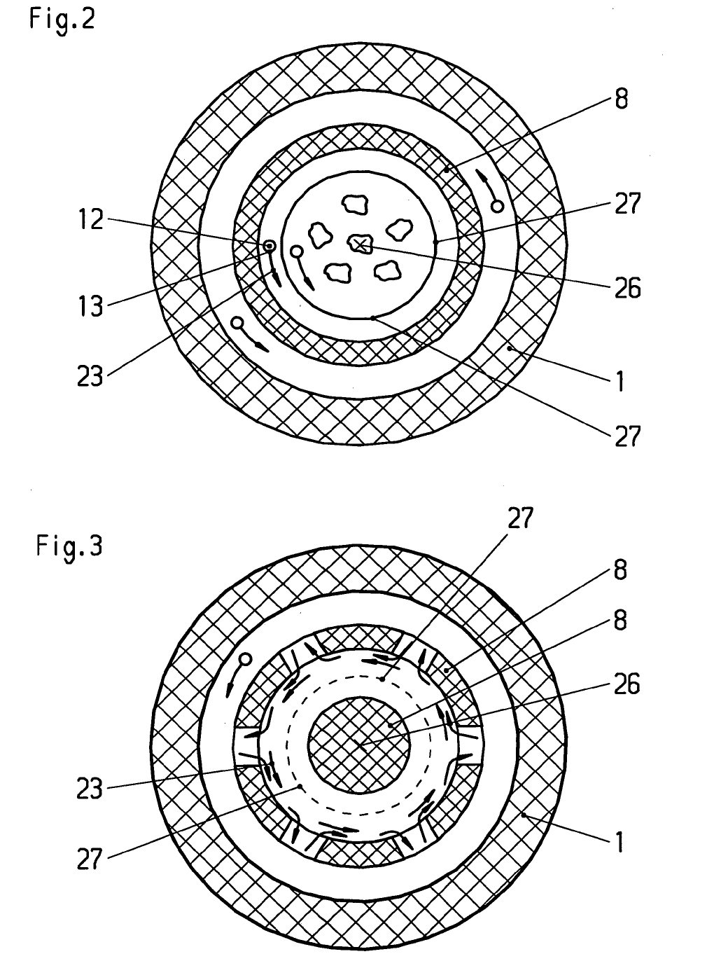

FIG. 2 a horizontal cross-section through the nozzle level in the upper area of the charge space of the pressurized vessel according to FIG. 1,

FIG. 3 another horizontal cross-section through the mixing level between the areas outside and inside the insulation of the pressurized vessel,

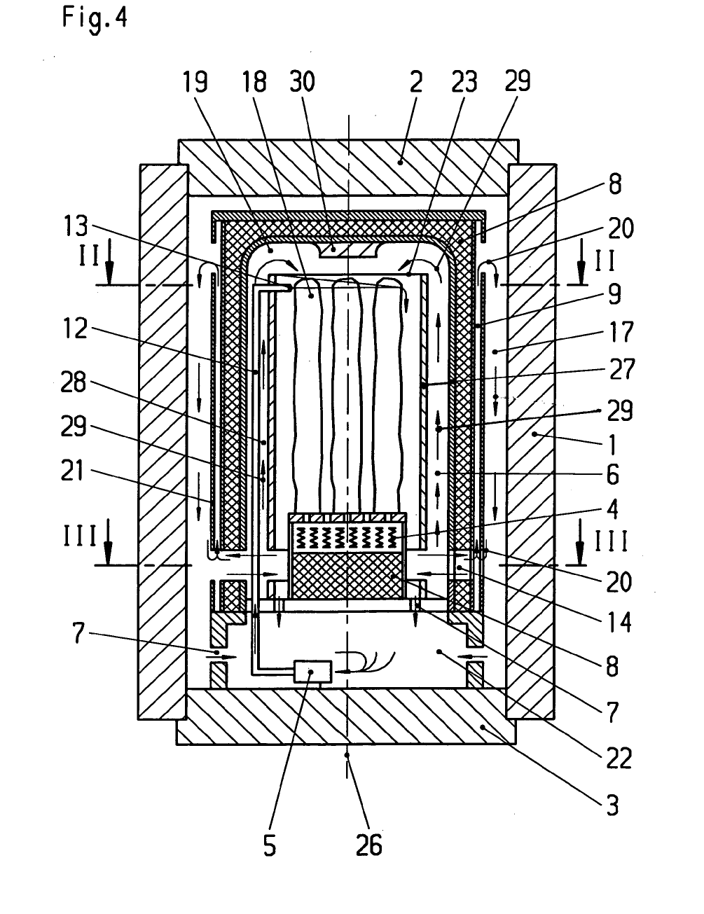

FIG. 4 a vertical cross-section through the central axis of a pressurized vessel with an internal rapid cooling via an exchanging device,

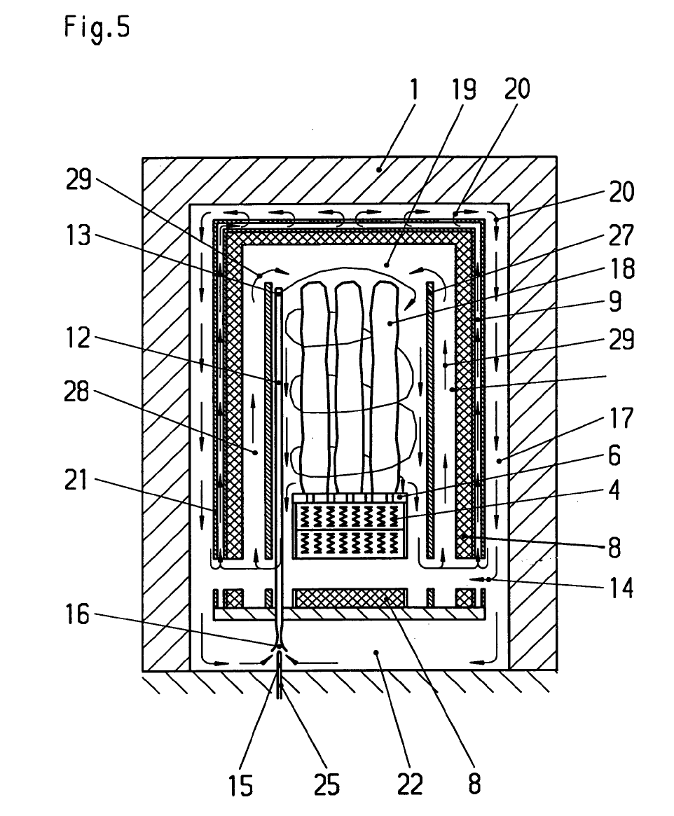

FIG. 5 another simplified exemplary embodiment with a concrete rotational flow inside a convection sheath, initiated by a nozzle inside a charge space, for rapid cooling.

The pressurized vessel 1 shown in the figures comprises a charge space 19, usually located inside, and an insulation 8 arranged between the charge space 19 and the exterior walls of the pressurized vessel 1. In order to embody a convection gap 28, a convection sheath 27 is arranged inside the charge space 19. In the following, as already described, a cooling of the pressurized vessel 1 is explained. An active heating with heated fluid or via heating elements occurs generically. Further, heating elements 4 are located inside the insulation 8 and a charge 18 is commonly arranged on a charge support plate 6 or in case of piece goods via a load carrier (not shown) placed on the charge support plate 6. Additionally, the pressurized vessel 1 comprises closing lids 2 and 3, which may serve for loading and unloading the pressurized vessel, however in the following they are considered allocated to the pressurized vessel 1 for simplifying the description. Inside the insulation 8 at least one nozzle 13 is arranged in the charge space 19, through which the fluid for the formation of a rotational flow 23 is injected, preferably with a high speed. The fluid may here show a lower temperature than the fluid in the charge space 19 and/or the charge 18 itself. Due to the laws of physics cool fluid is pressed by the rotational flow 23 to the interior wall of the insulation 8. The rotational flow 23 falls during the rotations in the charge space towards the bottom, while simultaneously the exterior, rotating colder fluid is mixed with the warmer fluid from the proximity of the charge 18. In a vertical cross-section through the central axis 26 of the pressurized vessel 1 the fluid with the highest temperature is therefore found in the proximity of the central axis 26. Thus, the temperature continuously drops in the direction towards the insulation 8 during the initialized rotational flow 23. In a preferred embodiment the fluid is injected horizontally towards the central axis 26 of the pressurized vessel 1 from at least one nozzle 13. A tangential injection of the fluid towards the central axis 26 of the pressurized vessel 1 is optimal. Of course, a high speed of the fluid exiting the nozzle 13 and/or the arrangement of several jets 13 are advantageous as well. They may be arranged according to the figures inside the convection sheath 27, outside the convection sheath 27, and/or outside the insulation 8. According to FIG. 4 the fluid is either taken with low temperature from the floor area 22 via a mixing device 5 and directly fed into the rising line 12 or it may be supplied as shown in FIG. 1 via an outlet 24 outside the pressurized vessel 1 to a fluid cooler 10 and subsequently injected via an inlet 25 into the line 12. In a particular preferred embodiment the cooled fluid returned via the inlet 25 into the pressurized vessel 1 is fed via an injector comprising a blow tube 15 and a venturi nozzle 16 into the line 12 (FIG. 1), with fluid from the bottom area 22 being mixed in. In all drive solutions for the rotational flow 23 the fluid can enter directly from the penetrations 7 from the charge space 19 and/or from the second annular gap 17 into the bottom area 22. This represents one possible design and is dependent on the necessary cooling speeds, because the fluid from the charge space 19 is significantly warmer than one from the second annular gap 17.

For a further optimization of the rapid cooling of the entire pressurized vessel 1, an exterior rotational circuit 20 can be established via natural convection in two annular gaps 9, 17 arranged parallel in reference to each other, with the rotational circuit 20 being arranged entirely outside the insulation 8.

The fluid of the exterior rotational circuit 20 and the rotating fluid from the charge space 19 can exchange and mix underneath the charge space via penetrations 14 in the insulation 8. Hot gas from the rotational flow 23 can here pass through the penetrations 14 into the exterior rotational circuit 20, where it is first mixed with the exterior circulatory flow and by the circulation at the wall of the pressurized vessel 1 is further cooled and can flow as a cooled gas via penetrations 14 back underneath the charge space 19.

By mixing the externally cooled fluid supplied via the inlet 25 and/or the fluid cooled in the exterior annular space 17 via the wall of the pressurized vessel 1 a very intensive and rapid cooling of the fluid is achieved and consequently also the charge space 19 for a rapid cooling according to FIG. 1 or 4. Of course, here one trained in the art knows a multitude of potential variants within the scope of this or other disclosures.

In another preferred embodiment according to FIG. 4 a guiding device 30 is arranged (at) the charge space 19. This guiding device 30 transfers the fluid flows moving between the charge space 19 and the convection gap 28 during the heating or the cooling process out of or into the edge regions of the charge space 19 in a careful manner. In both embodiments beneficial advantages result, such as in case of a transfer of cold fluid from the convection gap 28 into the charge space 19 it is prevented that the cold flow falls uncontrolled into the center of the charge space 19 onto the charge, because its enters near the edge at the inside of the convection sheath 27 into the interior of the convection sheath and is entrained by the rotational flow initiated here or it is pressed to the interior of the convection sheath 27 by an active rotational flow in the charge space 19. Inversely, a suitable embodiment of the guiding device 30 shall avoid in a fluidic aspect that an uncalculated second flow rises upwards in the middle of the convection sheath 27, is cooled here, and falls downward or that uncontrolled poorly mixed flows develop in the proximity of the central line 26 during the transfer.

Other preferred exemplary embodiments in the context with the teaching of the invention are the following: In order to force an immediate mixing of the cool fluid exiting the nozzle 13 with hot fluid from the proximity of the upper insulation 8 it is possible to inject the fluid from the nozzle 13 into an injector (not shown). In another variant additional penetrations 7 may be provided between the exterior annular gap 17 and the bottom area 22, allowing the fluid cooled at the wall of the pressurized vessel 1 to immediately flow back to the bottom area 22 (FIG. 4).

FIG. 5 shows a simplified illustration of an exemplary embodiment. Here, via a line 12 and the nozzle 13 injection occurs into the charge space 19 in a targeted fashion in order to establish a rotational flow 23 inside the convection sheath 27. Here, the charge 18 is impinged by a cooler fluid, which entrains via the injection tube 15 and the venturi nozzle 16 cool fluid from the bottom area 22 and injects it via the line 12 and the nozzle 13 into the charge space 19. Simultaneously, a mixed temperature develops inside the charge space 19 and the convection sheath 27, which cools the charge 18 in a careful manner. The convection sheath 27 emits the fluid below the charge 18, in this example underneath the heating element 4, to the convection gap 28, in which it is suctioned back upwards and reenters the charge space above the injection via the nozzle 13. For an ultra rapid cooling it is provided that proportionally the fluids exiting underneath the convection sheath 27 can exit via the penetrations 14 into the insulation 8 and can transfer into an exterior annular gap 17 and an interior annular gap 9. Here, the fluids preferably rise upwards via an annular gap 9 over a warm jacket surface located at the insulation 8 and forms a second rotational circuit 20. It preferably exits at the top underneath the lid of the pressurized vessel 1 from the annular gap 9 into the exterior annular gap 17, which contacts the cold jacket surface of the pressurized vessel 1. Most of the cold volume from the exterior annular gap 17 collects at the bottom area 22, by exiting as described via the venturi nozzle 16 and the line 12 through the nozzle 13 directly, which is particularly important in this exemplary embodiment, inside the charge space 19 and/or the convection sheath 28. The system for cooling described in greater detail can be applied accordingly for heating as well, with the heating occurring conventionally via pure heating elements and/or additionally via heated fluid. A targeted redistribution of the fluid from warm and/or cold areas of the pressurized vessel is possible by suctioning and/or transportation in the line 12 towards the nozzle 13, even in case of heating.

### LIST OF REFERENCE CHARACTERS

1. Pressurized vessel
2. Closing lid, top
3. Closing lid, bottom
4. Heating elements
5. Mixing device
6. Charge support plate, bottom plate
7. Penetrations
8. Insulation
9. Annular gap 1
10. Fluid cooler
11. Compressor
12. Line
13. Nozzle
14. Penetrations
15. Injection tube
16. Venturi nozzle
17. Annular gap, exterior
18. Charge
19. Charge space
20. Rotational circuit, exterior
21. Guiding panel for 20
22. Bottom area
23. Rotational flow
24. Outlet
25. Inlet
26. Central line
27. Convection sheath
28. Convection gap
29. Rotational flow, interior
30. Guiding device

1. A method for tempering a hot isostatic press, comprising a pressurized vessel (1) with a charge space (19) located inside and insulation (8) arranged therebetween, with inside the insulation (8) heating elements (4) and a charge space (19) with a charge (18) being arranged, with at least the charge space (19) being surrounded with a convection sheath (27) to form a convection gap (28), characterized in that inside the pressurized vessel (1) and/or the charge space (19) fluid is injected via at least one nozzle (13) to form a rotational flow (23) and here mixes with the fluid present there and that simultaneously the fluid forms a rotational circuit (29) around the convection sheath (27) and enters from the convection gap (28) into the charge space (19).

2. A method according to claim 1, characterized in that the injection occurs from a nozzle (13) tangentially in reference to an arc around the central axis (26) of the pressurized vessel (1).

3. A method according to claim 1, characterized in that injection occurs from the nozzle (13) into the charge space (19) at an angle diagonal in reference to the horizontal.

4. A method according to claim 1, characterized in that guiding panels support or hinder the rotational flow in the convection gap (28) of the pressurized vessel (1).

5. A method according to claim 1, characterized in that for a further optimization of the tempering an exterior rotational circuit (20) is established via natural convection (in two parallel annular gaps (9, 17) arranged parallel in reference to each other), which is arranged completely outside the insulation (8) in the pressurized vessel (1).

6. A method according to claim 1, characterized in that in rapid cooling the fluid exiting the nozzle (13) is supplied with a lower temperature from the bottom area (22) directly into the line (12).

7. A method according to claim 1, characterized in that during rapid cooling fluid is supplied via an outlet (24) to a fluid cooler (10) outside the pressurized vessel (1) and subsequently via an inlet (25) into the line (12).

8. A method according to claim 1, characterized in that in rapid cooling in the bottom area (22) the fluid cooled outside the pressurized vessel (1) is supplied via an injector comprising an injection tube (15) and a venturi nozzle (16) either directly or by mixing in fluid from the bottom area (22) into the line (12).

9. A method according to claim 1, characterized in that in rapid cooling the fluid of the rotational flow (23) enters from the charge space (19) underneath the charge space (19) via penetrations (14) in the insulation (8) into the exterior rotational circuit (20) and mixes with the fluid of the exterior rotational circuit (20), then flows by the circulation past the wall of the pressurized vessel (1) and flows back as a cooler fluid via penetrations (14) underneath the charge space (19).

10. A method according to claim 1, characterized in that the fluid is either exchanged via penetrations (7) located vertically between the charge space (19) and the bottom area (22) and/or between horizontally arranged penetrations (7) and the bottom area (22).

11. A method according to claim 1, characterized in that in rapid cooling the fluid of the interior rotational circuit (29) after exiting the convection gap (28) and prior to entering the charge space (19) is subjected to an even inversion of the direction in a guiding device (30) and transfers into the charge space (19) not at the center of said charge space (19).

12. A hot isostatic press, comprising a pressurized vessel (1) with a charge space (19) located at its interior and insulation (8) arranged therebetween, with inside the insulation (8) heating elements (4) and a charge space (19) being arranged with a charge (18), with at least the charge space (19) being surrounded by a convection sheath (27) to form a convection gap (28), characterized in that inside the pressurized vessel (1) at least one line (12) is arranged connected to at least one nozzle (13) at the inside of the pressurized vessel (1), with the exit angle of the nozzle (13) in reference to a rotational flow (23) inside the charge space (19) being appropriate and with the line (12) being connected to an area of the pressurized vessel (1) having a different temperature.

13. A hot isostatic press according to claim 12, characterized in that the outlet direction of the nozzle (13) is arranged horizontally and/or tangentially in reference to the central axis (26) of the pressurized vessel (1).

14. A hot isostatic press according to claims 12 and/or 13, characterized in that the outlet direction of the nozzle (13) is arranged tangentially in reference to the central axis (26) and sloped upwards or downwards in reference to the horizontal.

15. A hot isostatic press according to one or more of claims 13 through 15, characterized in that in the upper and/or lower area of the charge space (19) a guiding device (30) is arranged for a targeted reversal of direction for the fluid alternating between the convection gap (28) and the charge space (19).

16. A hot isostatic press according to claim 13, characterized in that at least one guiding pane is arranged in the pressurized vessel (1) or at least in the convection gap (28) to support or hinder the rotational flow.
